(19) United States
(12) Patent Application Publication
(10) Pub. No.: US 2026/0300682 A1
(43) Pub. Date: Oct. 1, 2026

(54) ENERGY-EFFICIENT ACCELERATION METHOD AND HARDWARE ACCELERATOR FOR DYNAMIC GRAPH NEURAL NETWORKS

(71) Applicant: HUAZHONG UNIVERSITY OF SCIENCE AND TECHNOLOGY, Wuhan (CN)

(72) Inventors: Yu ZHANG, Wuhan (CN); Xintao LI, Wuhan (CN); Hui YU, Wuhan (CN); Jin ZHAO, Wuhan (CN); Xiaofei LIAO, Wuhan (CN); Hai JIN, Wuhan (CN)

(21) Appl. No.: 19/427,095

(22) Filed: Dec. 19, 2025

(30) Foreign Application Priority Data
Apr. 1, 2025 (CN) 202510405577.9

(51) Int. Cl. G06N 3/042

(52) U.S. Cl. CPC G06N 3/042

(57) ABSTRACT

An energy-efficient acceleration method and hardware accelerator for dynamic graph neural networks (DGNNs) are provided. The method includes: dynamically tracking original dependency chains using a dynamic dependency chain generation algorithm; storing active vertices in a chain-driven FIFO buffer according to a dependency order among the active vertices; prefetching a source vertex, a target vertex, a dependency chain, and associated graph data features from the FIFO buffer into a prefetch buffer; scheduling the source and target vertices to an aggregation buffer of an aggregation engine, and scheduling the source vertex state and corresponding edge states to a second application buffer of a second application engine, such that the aggregation engine and the second application engine execute state aggregation and edge computation in parallel; and scheduling the aggregation results and edge computation results to a first application engine for fusion, thereby generating a final state of the target vertex.

### BACKGROUND OF THE APPLICATION

### 1. Technical Field

The present disclosure generally relates to the fields of graph data processing and artificial intelligence chip technologies, and more particularly, to an energy-efficient acceleration method and hardware accelerator for dynamic graph neural networks (DGNNs).

### 2. Description of Related Art

With the advent of the big data era, graph structures—which can effectively represent data correlations—have been widely adopted in applications such as Internet services, data mining, and scientific computing. Many important graph-based applications, including path analysis, product recommendation, and social network analysis, rely on graph neural networks (GNNs) to iteratively process graph data until convergence.

In GNNs, vertices follow a neighborhood aggregation scheme, communicating iteratively with adjacent vertices through a synchronous message-passing mechanism. However, recent studies have shown that GNN training often requires frequent inter-layer global synchronization, which significantly impairs computational efficiency. To address this limitation, a more efficient architecture—dynamic graph neural networks (DGNNs)—has been developed. Unlike common GNNs, in DGNNs, the state of each vertex (i.e., its feature vector) is dynamically updated by aggregating and transforming the states of adjacent vertices until convergence. Furthermore, the gradients and embeddings generated in DGNNs have been shown to exhibit favorable convergence properties.

Despite the availability of various software DGNN systems and hardware GNN accelerators, these solutions still suffer from substantial redundant computation and off-chip communication overhead for two main reasons. First, in each DGNN iteration, active vertices processed by different cores propagate their updated states to adjacent vertices along dependency chains in a dynamic and irregular manner. Consequently, many vertices may update their states based on stale neighbor information, resulting in unnecessary computations. Second, vertex states are typically large and cannot be fully accommodated in on-chip memory; instead, they are sparsely stored off-chip, causing severe irregular memory access patterns during DGNN inference.

For example, CN113313243A discloses a method, device, equipment and storage medium for determining a neural network accelerator. The method includes: acquiring a neural network model set and an accelerator structure set, wherein the neural network model set comprises at least one neural network model, and the accelerator structure set comprises at least one accelerator structure; determining at least one neural network accelerator based on the combination of the model set and the structure set, each accelerator being defined by at least one neural network model and one accelerator structure, and used for processing data of a specific type; determining design parameters for each accelerator, and evaluating its performance metrics based on these parameters; and selecting a target neural network accelerator according to the performance metrics. However, this known solution exhibits certain limitations: in graph scenarios, it may generate redundant computations because vertex state updates require global synchronization, and its hardware architecture lacks modularity tailored for graph operations, resulting in lower efficiency during aggregation and propagation steps in GNNs.

Note that, due to potential discrepancies in understanding among those skilled in the art, and the extensive literature and patents reviewed by the applicant during development, not all details are listed due to space constraints. This does not imply that the present disclosure lacks existing art features; rather, it encompasses all relevant existing art features. The applicant reserves the right to supplement this application with further details and features from related existing art, as appropriate, in accordance with relevant regulations.

### SUMMARY OF THE APPLICATION

To address the deficiencies of the existing art, the present disclosure, from a first aspect, provides an energy-efficient acceleration method for dynamic graph neural networks (DGNNs), the method including: using an unvisited active vertex as a root vertex, dynamically tracking an original dependency chain based on a dynamic dependency chain generation algorithm, until all active vertices are visited; storing the active vertices into a chain-driven FIFO buffer in accordance with a dependency order among the active vertices, thereby aligning a processing sequence with a data propagation path; sequentially prefetching, from the chain-driven FIFO buffer in accordance with the dependency order, a source vertex, a target vertex, a dependency chain between the target vertex and its adjacent vertices, and graph data features associated with the dependency chain, and storing them into a prefetch buffer; scheduling the source vertex and the target vertex from the prefetch buffer to an aggregation buffer of an aggregation engine, and further scheduling a source vertex state and its corresponding edge states to a second application buffer of a second application engine, such that the aggregation engine and the second application engine execute state aggregation and edge computation in parallel; and scheduling an aggregation result from the aggregation engine and an edge computation result from the second application engine to a first application engine for fusion, thereby generating a final state of the target vertex.

The present disclosure employs a chain-aware processing mechanism to normalize data access, dynamically tracks dependency chains among active vertices, and processes vertices sequentially based on their positions on the chain, thereby avoiding redundant data access and unnecessary computation related to vertex state updates. This ensures that vertex states propagate efficiently along dependency chains and significantly accelerates the convergence of iterative graph processing.

According to a preferred embodiment, the dynamic dependency chain generation algorithm includes: acquiring vertices from either an active bit vector buffer or an intermediate queue buffer; acquiring head and tail offsets of an active vertex from a vertex array of a graph structure buffer; acquiring unvisited adjacent vertices of the active vertex from an adjacent vertex array of the graph structure buffer and sending the adjacent vertex to the intermediate queue buffer and the chain-driven FIFO buffer; and updating entries corresponding to the adjacent vertices in the active bit vector buffer from active to inactive, thereby enabling subsequent adjacent-vertex selection.

An active bit vector is used to determine whether a vertex participates in the current iteration, excluding inactive vertices (such as converged vertices) from computation to reduce processing overhead. The cooperative operation of the intermediate queue buffer and the chain-driven FIFO buffer ensures that only valid adjacent vertices are processed. Active adjacent vertices are marked as “inactive” in real time to prevent repeated updates to the same vertex during a single iteration.

According to a preferred embodiment, the step of prefetching includes: extracting the source vertex from the chain-driven FIFO buffer in accordance with the dependency order; retrieving all adjacent vertices of the source vertex from an associated edge array and generating the dependency chain in the dependency order; and from an input feature buffer, extracting the source vertex state, a target vertex state, and the edge states corresponding to each edge in the dependency chain.

This prefetching strategy exploits spatial locality to load features of vertices along the dependency chain into an on-chip prefetch buffer, reducing randomness in off-chip memory access. Prefetched data is standardized to include source/target vertex IDs and states, allowing a first active computation unit or a second active computation unit to process data without additional parsing, thereby reducing preprocessing latency by approximately 20%.

According to a preferred embodiment, the method of the present disclosure further includes a chain-aware data caching strategy that is configured to manage the vertex states in the input feature buffer, wherein, upon a request for the state of a said vertex, if the input feature buffer has not reached its maximum capacity, the vertex state is cached directly, or otherwise, a priority of the vertex is computed and the vertex replaces a resident vertex with the lowest priority.

The chain-aware data caching strategy of the present disclosure prioritizes caching states of vertices along frequently accessed dependency chains in on-chip memory, effectively reducing unnecessary off-chip communication, improving data locality, and alleviating performance bottlenecks caused by excessive data transfer, thereby promoting efficient utilization of the hardware accelerator.

According to a preferred embodiment, the priority of the vertex is defined as:

$$Pri ( v ) = \frac{{P}_{G} ( v )}{{P}_{G}} \times {D}_{v} ,$$

where P_{G} denotes a number of said dependency chains in a graph, P_{G}(v) denotes a number of said dependency chains involving the vertex v, and Dᵥ denotes a degree of the vertex v.

The chain-aware data caching strategy quantifies vertex priority Pri(v) to dynamically manage the input feature buffer. In practice, such as in e-commerce recommendation systems, the states of high-frequency items (high) and popular users (high) are preferentially cached, with priority values up to 6-8 times higher than ordinary nodes.

According to a preferred embodiment, the aggregation engine executes the state aggregation by: preloading the adjacent vertex states generated in the previous computation into the aggregation buffer and applying an aggregation operator to generate the aggregation result.

The preloading mechanism of the aggregation engine enables computations without waiting for data loading. The aggregation buffer employs a multi-bank architecture that supports concurrent loading of multiple adjacent vertex states (e.g., vertices B and C), thereby increasing aggregation throughput.

According to a preferred embodiment, the second application engine executes the edge computation by: fusing the states of the source and target vertices with edge attribute data to generate edge message-passing features, and transmitting the edge message-passing features to the first application engine.

Edge computation tasks executed by the second application engine are separated from vertex aggregation, suitable for scenarios with significantly more edges than vertices (e.g., recommendation systems). The second application buffer stores edge states (e.g., weight coefficients), avoiding bandwidth contention with vertex states.

According to a preferred embodiment, the first application engine operates by: computing an updated state of the target vertex by performing matrix-vector multiplication and nonlinear transformation; and sending the updated state of the target vertex to an output buffer and the input feature buffer.

The first application engine's fused computation ensures vertex states while incorporating both aggregated features of adjacent vertices and edge message-passing features, avoiding bias from single data sources.

The present disclosure, from a second aspect, provides an energy-efficient hardware accelerator for dynamic graph neural networks (DGNNs), wherein the hardware accelerator includes: a chain-driven traversal unit, a chain-driven processing unit, and an on-chip buffer. The chain-driven traversal unit tracks a dependency chain of an active vertex using a dynamic dependency chain generation algorithm, stores the active vertices into a chain-driven FIFO buffer in accordance with a dependency order among the active vertices, thereby aligning a processing sequence with a data propagation path, and sequentially prefetches, from the chain-driven FIFO buffer in accordance with the dependency order, a source vertex, a target vertex, a dependency chain between the target vertex and its adjacent vertices, and graph data features associated with the dependency chain, and stores them into a prefetch buffer. The chain-driven processing unit schedules a source vertex and/or a target vertex of a prefetch buffer to an aggregation engine, and further schedules a source vertex state and edge states to a second application engine, thereby enabling parallel execution of aggregation and edge computation, and sends results of the parallel execution to a first application engine, thereby generating a final state of the target vertex. And the on-chip buffer includes a chain-driven FIFO buffer, a prefetch buffer, and an input feature buffer, wherein the input feature buffer manages vertex states using a chain-aware data caching strategy.

According to a preferred embodiment, the chain-driven processing unit adopts a multi-core vector processor array architecture and comprises an aggregation engine, which is a MAC array, and two application engines, which are vector ALUs.

According to a preferred embodiment, the aggregation engine is physically connected to the first application engine, and the first application engine is physically connected to the second application engine. The aggregation engine includes an aggregation buffer and an aggregation scheduler, and the first application engine includes a first application buffer, a first application scheduler, and a first active computation unit.

According to a preferred embodiment, the first application buffer is configured to store input data that include the source vertex state, a target vertex state, and the edge states. The first application scheduler reads data from the first application buffer and assigns tasks to the first active computation unit. The first active computation unit feeds computation results to the first application buffer. The first application buffer transmits the computation results to the aggregation engine, the second application engine, or a high-bandwidth memory, thereby completing data exchange.

According to a preferred embodiment, the second application engine includes a second application buffer, a second application scheduler, and a second active computation unit, and is connected to the first application engine via a switch. The second application buffer stores the source vertex state and the edge states for use by the second application engine in edge computation and vertex updates.

According to a preferred embodiment, the second application buffer receives and stores input data that include a target vertex initial state, an aggregation result, and an edge computation result. The second application scheduler reads data from the second application buffer and assigns tasks to the second active computation unit. The second active computation unit computes a final state of the target vertex, and stores it to the second application buffer. The second application buffer transmits the computation result to the high-bandwidth memory or a subsequent first application engine for storage, thereby completing vertex updates.

According to a preferred embodiment, the switch is configured to merge the first application engine and the second application engine into a single, larger application engine.

According to a preferred embodiment, the switch merges the first application engine and the second application engine by dynamically adjusting data paths, sharing the computing resources, and unifying task scheduling.

According to a preferred embodiment, in a merge mode, when computing tasks are biased toward vertex updates or explicit edge computation is not required, the switch reconfigures a dataflow such that the first application buffer and the second application buffer share data storage space, and the first active computation unit cooperates with the second active computation unit to perform vertex computation, thereby improving computing resource utilization and enhancing computing throughput.

According to a preferred embodiment, the chain-driven processing unit communicates with the chain-driven FIFO buffer via a duplex crossbar network that supports 8-way concurrent access for prefetching vertex features and edge weight data, and is crossbar-connected to the input feature buffer, which is implemented using a multi-bank architecture, thereby enabling rapid loading and updating of 32-bit floating-point vector states.

According to a preferred embodiment, a control unit manages global tasks, allocate computing resources, control dataflow, and perform synchronization management, and coordinates execution of the first application engine, the second application engine, the aggregation engine, and the scheduling unit, thereby ensuring a dynamic pipeline with efficient operation. The control unit also dynamically allocates the computing resources and, in conjunction with the switch, optimizes execution by merging the first active computation unit and the second active computation unit, and further manages the input feature buffer to improve memory access efficiency. The control unit further synchronizes the computation tasks to prevent data conflicts and handles exceptions, thereby ensuring stable and efficient DGNN inference.

The present disclosure provides an energy-efficient dynamic graph processing acceleration method for dynamic graph neural networks (DGNNs), achieving the following technical effects: a hardware accelerator dynamically maintains a dependency topology chain of active vertices using a chain-driven FIFO buffer. A prefetch buffer performs pipelined, order-aware preloading of vertex features along the dependency chain, thereby ensuring strict alignment between the data access path and the processing sequence, and effectively reducing redundant memory access overhead. Parallel computation paths are established between the aggregation engine and the second application engine, enabling pipelined execution of vertex aggregation, edge computation, and final state generation, thereby substantially increasing data throughput efficiency. The chain-aware data caching strategy in the input feature buffer accelerates vertex state propagation along the dependency chain while reducing on-chip memory access energy consumption and ensuring computational accuracy. The overall architecture adopts a dependency-driven chain-based processing mechanism, thereby jointly optimizing computing resource utilization and memory access efficiency, and achieving a 2.1× improvement in energy efficiency compared with common dynamic graph processing architectures.

According to a preferred embodiment, the chain-aware data caching strategy includes: upon a request for the state of a said vertex, if the input feature buffer has not reached its maximum capacity, the vertex state is cached directly, or otherwise, a priority of the vertex is computed and the vertex replaces a resident vertex with the lowest priority. The chain-aware data caching strategy of the present disclosure prioritizes the on-chip caching of states frequently accessed along dependency chains, thereby effectively reducing unnecessary off-chip communication and improving data locality, mitigating performance bottlenecks caused by excessive data transfer overhead, and further facilitating efficient utilization of the hardware accelerator.

### BRIEF DESCRIPTION OF THE DRAWINGS

FIG. 1 is a schematic diagram illustrating the inference logic of an energy-efficient acceleration method for DGNNs provided by the present disclosure;

FIG. 2 is a schematic diagram illustrating an example of graph data and two associated dependency chains according to the present disclosure;

FIG. 3 is a schematic diagram illustrating the architecture of an energy-efficient hardware accelerator for DGNNs provided by the present disclosure;

FIG. 4 is a flowchart illustrating an embodiment of the energy-efficient acceleration method provided by the present disclosure; and

FIG. 5 is a schematic diagram illustrating the microarchitectures of a chain-driven traversal unit and a chain-driven processing unit provided by the present disclosure.

### DETAILED DESCRIPTION OF THE EMBODIMENTS

A detailed description is provided below with reference to the accompanying drawings.

Certain technical terms used herein are further defined as follows.

A chain-aware mechanism optimizes data access and processing order during DGNN inference by dynamically tracking dependency chains among graph vertices. The dependency chain serves as the core driver for vertex state updates. The graph data are sequentially accessed and processed along the dependency chain to ensure that each vertex is updated based on the latest states of its adjacent vertices.

An active vertex refers to a vertex in DGNN inference configured to perform computation, propagate states, or receive updates. Active vertices constitute the core elements of the dependency chain and drive the process of state update and propagation.

Depth-first traversal refers to a traversal strategy for graphs starting from a designated starting vertex (or a root vertex) and proceeding along a single path until reaching an ending vertex or encountering no unvisited adjacent vertices. The process then backtracks and continues along other paths until a completion requirement is satisfied (such as all vertices having been visited or a predefined threshold being reached).

A dependency chain is a dependency path for vertex state updates in a DGNN, composed of topological connection paths in the graph. The vertex sequence in the chain strictly defines the temporal dependency order for state propagation.

An edge array is a basic data container for recording the graph topology, comprising an ordered list of source and target vertices indices for all edges. Each edge is associated with specific source and target vertices based on its storage position. The edge array provides index-based mapping to construct adjacency lists, thereby supporting efficient adjacent edge retrieval.

An offset array is an indexing structure that operates in conjunction with the edge array. It stores start and end index positions (start_offset and end_offset) of adjacent edges of each vertex in the edge array, enabling O(1) complexity for locating adjacent edges. The design enhances spatial locality and reduces full-graph traversal overhead.

An adjacent vertex array is an array structure for storing adjacency relationships between vertices. It employs a storage format compatible with sparse graph representation. The adjacent vertices of each vertex are arranged in a predefined order, enabling efficient access to adjacent vertices and their associated edge data.

An adjacent vertex is a vertex directly connected to the current vertex via an edge. In GNN processing, the state vector of each adjacent vertex is incorporated into the computation for state update of the current vertex, wherein the accuracy of adjacency selection critically influences inference effectiveness.

A source vertex ID is the unique identifier of a vertex extracted from the chain-driven FIFO buffer, which as source vertex ID initiates the loading of adjacent edge data and triggers the corresponding state computation process for that vertex.

A target vertex ID is the unique identifier of a vertex adjacent to the source vertex. During the generation of a dependency chain, the target vertex ID is used to identify the receiver of the propagated state update, forming the successor sequence in the dependency chain.

A vertex state is a collection of data representing the features of a vertex, which may include original attribute data or multidimensional feature vectors transformed by a neural network. During computation, it serves as core input parameter for message passing and state update operations.

An edge state is a set of feature data describing edge attributes, including weight coefficients, type labels, and custom feature vectors. It participates in the information propagation process between the source vertex and the target vertex in a GNN.

A chain-driven execution mechanism dynamically schedules computations along dependency chains. By tracking the topological order of active vertices along the chain, the mechanism enforces sequential state updates, thereby minimizing redundant computation and avoiding unnecessary data access.

An aggregation engine is a computation unit configured to aggregate adjacent vertex states using aggregation operators such as summation, averaging, and maximum operation, and to provide the aggregated result to a second application engine.

A first application engine is a computation unit configured to update vertex states by performing matrix-vector multiplication and applying activation functions, so as to generate new state vectors for target vertices.

A second application engine is a dedicated unit configured to perform edge computation by integrating the source vertex state, target vertex state, and edge attribute data to generate edge transmission features, and to output the features to the first application engine.

### Embodiment 1

Existing DGNN systems and dedicated hardware accelerators face dual performance challenges due to a fundamental conflict between dynamic computation paradigm and intrinsic properties of graph data.

First, the dynamic state propagation mechanism incurs substantial redundant computation. During DGNN iterations, multiple processing cores concurrently update active vertices that propagate their states to adjacent vertices along dynamic dependency chains. In the absence of global synchronization, update time windows among processing cores exhibit significant misalignment. As a result, when one vertex completes its state update, its adjacent vertices may still perform computations based on the vertex's outdated state, leading to results that deviate from the actual latest state. This “stale-state dependency” results in approximately 60% of invalid updates per iteration and causes erroneous states to cascade across multi-hop neighbors. Experiments demonstrate that such redundancy leads to 58-72% computing resource waste and 22-35% additional off-chip communication overhead.

Second, the high-dimensional nature of vertex states gives rise to a severe memory wall problem. In modern GNNs, each vertex is typically composed of hundreds to thousands of floating-point features, whose storage demand far exceeds the capacity of on-chip caches, thereby forcing the majority of state data to be stored in off-chip DRAM. This design leads to a fundamental mismatch: dependency chains generated dynamically result in highly irregular vertex processing orders, whereas off-chip DRAM achieves its optimal bandwidth only under sequential access. For instance, when the system processes vertices in the order A→D→B→C according to a dependency chain, the corresponding physical addresses in DRAM may be scattered across non-contiguous banks, giving rise to frequent bank conflicts and cache line thrashing. Empirical measurements indicate that such irregular accesses reduce memory bandwidth utilization to less than 30%, while off-chip data transfers consume 64-79% of the total system energy.

The coupled effect of this dual bottleneck imposes significant deficiencies on existing systems in both computational effectiveness and energy efficiency: redundant updates inflate unnecessary off-chip traffic, while irregular access further exacerbates the idleness of computing resources. Benchmark evaluations demonstrate that these combined issues cause system-level energy efficiency to deteriorate by approximately 3.8× compared with the theoretical optimum, thereby constituting a critical obstacle to the practical deployment of DGNNs in resource-constrained scenarios such as edge computing devices.

To address the shortcomings of the existing art, the present embodiment provides an energy-efficient acceleration method and hardware accelerator for DGNNs. The present disclosure also provides an energy-efficient acceleration method and system for DGNNs. The present disclosure further provides an electronic device equipped with the disclosed hardware accelerator. The present disclosure additionally provides a processor configured to perform the disclosed energy-efficient acceleration method for DGNNs.

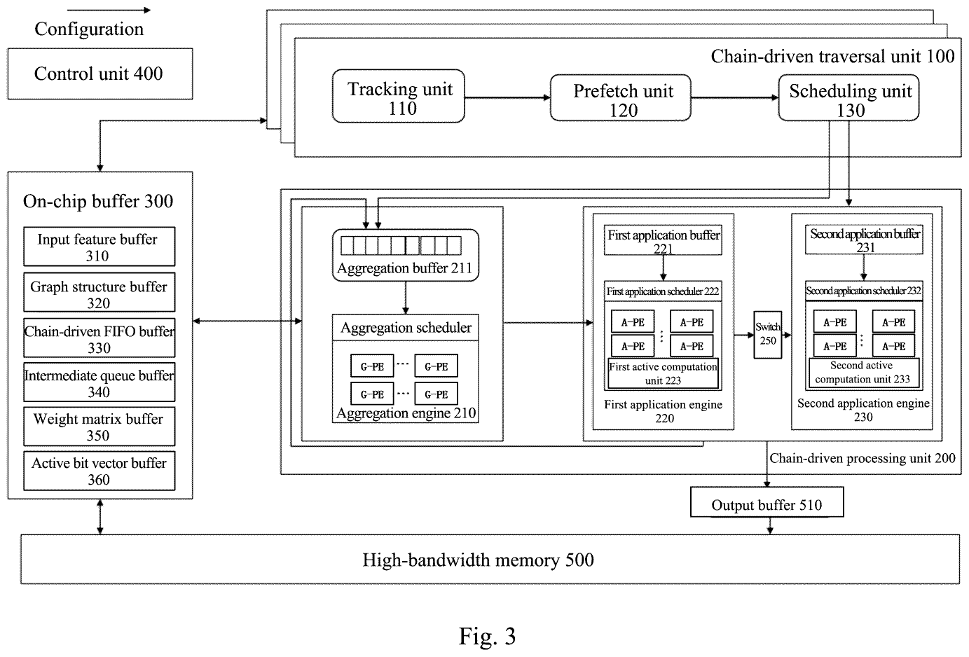

As illustrated in FIG. 3, the hardware accelerator comprises a chain-driven traversal unit (CDTU) 100, a chain-driven processing unit (CDPU) 200, and an on-chip buffer 300. Preferably, the hardware accelerator is further equipped with a control unit 400. Preferably, the hardware accelerator is connected to a high-bandwidth memory 500 to form an output buffer 510.

The chain-driven traversal unit 100 may be implemented in hardware using a dedicated state machine (ASIC) or a programmable logic (FPGA), and comprises a built-in graph structure parser that dynamically generates dependency chains. For example, the chain-driven traversal unit 100 is connected to the on-chip buffer 300 via a 512-bit AXI4-Stream bus to read vertex offset and adjacency list data in real time. The generated dependency chain sequence, including vertex IDs and timestamps, is written to the chain-driven FIFO buffer 330 through a dynamic-width bridge.

The chain-driven processing unit 200 adopts a multi-core vector processor array architecture and comprises an aggregation engine 210 (MAC array) and two application engines (vector ALUs). As illustrated in FIG. 3, the aggregation engine 210 is physically connected to the first application engine 220, which is in turn physically connected to the second application engine 230. The aggregation engine 210 comprises an aggregation buffer 211 and an aggregation scheduler. The first application engine 220 comprises a first application buffer 221, a first application scheduler 222, and a first active computation unit 223.

Preferably, the first application buffer 221 is configured to store input data, including source vertex states, target vertex states, and edge states. The first application scheduler 222 is configured to read data from the first application buffer 221 and assign tasks to the first active computation unit 223. The first active computation unit 223 outputs its computation results to the first application buffer 221. The first application buffer 221 is further configured to transmit the computation results to the aggregation engine 210, the second application engine 230, or the high-bandwidth memory 500 to complete data exchange.

The second application engine 230 comprises a second application buffer 231, a second application scheduler 232, and a second active computation unit 233. A switch 250 is provided between the first application engine 220 and the second application engine 230. The second application buffer 231 is configured to store the source vertex state and the edge states for use by the second application engine 230 during edge computation and vertex updates.

The second application buffer 231 is configured to store input data, including the initial state of the target vertex, aggregation results, and edge computation results. The second application scheduler 232 is configured to read data from the second application buffer 231 and assign tasks to the second active computation unit 233. The second active computation unit 233 is configured to compute a final state of a target vertex and write the result to the second application buffer 231. The second application buffer 231 is further configured to transmit the computed result to the high-bandwidth memory 500 or to the subsequent first application engine 220, thereby completing the vertex updates.

Preferably, the switch 250 is configured to merge the first application engine 220 and the second application engine 230 into a unified, larger application engine.

The switch 250 merges the first application engine 220 and the second application engine 230 by dynamically adjusting data paths, sharing computing resources, and unifying task scheduling. In a merge mode, when computing tasks are biased toward vertex updates or explicit edge computations are not required, the switch 250 reconfigures a dataflow such that the first application buffer 221 and the second application buffer 231 share a data storage space, and the first active computation unit 223 cooperates with the second active computation unit 233 to perform vertex computation, thereby improving computing resource utilization and enhancing throughput. The switch 250 further allows the two application schedulers to operate cooperatively to dynamically assign tasks, ensuring balanced workload distribution. By centrally managing task scheduling, the switch 250 ensures full utilization of computing resources and avoids idleness of the first active computation unit 223 and/or the second active computation unit 233. This mechanism enables the system to adapt to dynamic changes in computational workloads, thereby optimizing throughput, reducing bottlenecks, and improving the overall performance of DGNN inference.

For DGNN variants without edge operations, the chain-driven processing unit 200 merges the first application engine 220 and the second application engine 230 into a unified, larger application engine by utilizing the control unit 400 and a dedicated hardware component, i.e., the switch 250. This integration enables efficient execution of vertex operations, thereby optimizing hardware resource utilization and improving overall efficiency of both the first and second active computation units 223, 233.

The chain-driven processing unit 200 communicates with the chain-driven FIFO buffer 330 via a duplex crossbar network that supports 8-way concurrent access for prefetching vertex features and edge weight data. Additionally, it is crossbar-connected to the input feature buffer 310, which is implemented using a multi-bank architecture, thereby enabling rapid loading and updating of 32-bit floating-point vector states.

Preferably, the control unit 400 comprises a standalone microcontroller (MCU) and is interconnected with the chain-driven traversal unit 100 and the chain-driven processing unit 200 via a hierarchical AMBA AXI bus, thereby performing priority scheduling, DMA transfers, and power domain management. Experimental results show that it improves task scheduling efficiency by 37% and reduces crossbar network conflicts.

The control unit 400 is configured to manage global tasks, allocate computing resources, control dataflow, and perform synchronization management. It coordinates the execution of the first application engine 220, the second application engine 230, the aggregation engine 210, and the scheduling unit 130, thereby ensuring efficient operation of the dynamic pipeline. The control unit 400 dynamically allocates computing resources and, in conjunction with the switch 250, optimizes execution by merging the first active computation unit 223 and the second active computation unit 233. It further manages the input feature buffer 310 to improve memory access efficiency. Furthermore, the control unit 400 synchronizes computation tasks to prevent data conflicts and handles exceptions, thereby ensuring robust and efficient DGNN inference.

In terms of backend memory extension, the hardware accelerator is physically connected to the high-bandwidth memory (HBM) 500 via a silicon interposer, using a 2.4 Gbps/pin interface protocol compliant with the JEDEC HBM PHY standard. The design adopts 2.5D integration technology to stack the processing unit and the HBM with a bump pitch of 55 μm, achieving an interconnect density of 10,000/mm². A source-synchronous clock (SSC) is employed to compensate for timing skew, thereby maintaining clock jitter within ±15 ps. Serving as an output buffer 510, the HBM 500 provides a capacity of 32 GB-representing a 256-fold increase compared with purely on-chip solutions- and supports burst-mode writeback of vertex states. With an interconnect bandwidth of ≥400 GB/s, corresponding to a memory-to-compute ratio of 1:4 against the 32-TOPS peak throughput of the processing unit, the design effectively prevents data starvation.

In physical implementation, energy efficiency is optimized through domain partitioning. Specifically, the chain-driven FIFO buffer 330 operates at 0.9 V and 800 MHz, while the core of the processing unit runs at 1.2 V and 1.5 GHz, with both domains independently regulated via dynamic voltage and frequency scaling (DVFS). Through deep integration of the processing unit and the HBM using the silicon interposer, the architecture supports single-card inference of graphs with millions of vertices, while achieving an effective memory bandwidth utilization exceeding 78%.

The on-chip buffer 300, as the core storage component of the hardware accelerator, may be implemented using either static random-access memory (SRAM) or a register file. The SRAM employs 6T storage cells and a sense amplifier array to detect small voltage signals (approximately 200 mV) with high precision, and adopts a multi-bank architecture that partitions the storage into 64 independently operable banks to enable fine-grained parallel access, such as concurrent read/write operations. The register file is implemented with full-custom routing to support wide-port configurations (e.g., 32 read ports and 16 write ports), thereby delivering ultra-low-latency access (<1 ns). The physical design further integrates timing control circuits—including a precharge clock tree and dedicated read/write timing generators—to ensure sub-nanosecond margins. Voltage domain partitioning is also applied, with the active region powered at 1.0 V and the sleep region at 0.6 V, thereby reducing static power consumption by more than 40%.

In terms of interconnection, the on-chip buffer 300 communicates with the chain-driven processing unit 200 via a 1024-bit unidirectional write bus and a 512-bit bidirectional read bus. A source-synchronous clock (SSC) compensates for delay variations, with clock jitter maintained within ±15 ps.

Preferably, the on-chip buffer 300 is partitioned into six regions to efficiently access data such as input features, graph structures, intermediate queues, weight matrices, and active bit vectors. These regions include an input feature buffer 310, a graph structure buffer 320, a chain-driven FIFO buffer 330, an intermediate queue buffer 340, a weight matrix buffer 350, and an active bit vector buffer 360.

Preferably, buffer regions of the on-chip buffer 300, such as the chain-driven FIFO buffer 330, are implemented as independent memory banks. For instance, the input feature buffer 310 is constructed using a multi-port SRAM, whereas the weight matrix buffer 350 may employ high-density ternary content-addressable memory (TCAM). The memory cells of different regions are physically isolated in layout and interconnected through dedicated metal-layer routing.

By way of example, the chain-driven FIFO buffer 330 integrates a ring pointer register and a state machine to implement hardware-level FIFO control logic, including auto-increment of read/write pointer and full/empty flag generation. The active bit vector buffer 360 adopts a configurable-width content-addressable memory (CAM) with parallel matching circuits, such as a 64-bit XOR comparator array. The intermediate queue buffer 340 incorporates row-buffer acceleration circuits to enable data prefetching in burst transfer mode.

The input feature buffer 310 is a memory region for storing feature data of vertices and edges in the graph, including vertex states and edge states to be accessed during inference.

The graph structure buffer 320 is a memory region for storing structured graph data, typically including vertex and edge information such as vertex degrees, adjacency relationships, and edge weights. In the hardware accelerator, the graph structure buffer 320 stores sparse representations of the graph (e.g. offset and edge arrays) to support subsequent computations.

The chain-driven FIFO buffer 330 (i.e., chain-based first-in-first-out buffer) is provided to store vertex information along dependency chains. It follows FIFO ordering to ensure that vertices within a dependency chain are processed in the correct sequence.

The intermediate queue buffer 340 is a buffer region used to store vertices pending processing during GNN inference. It temporarily holds vertices that have not been fully processed, ensuring orderly execution of computation tasks. Upon completion of a vertex's state update, the vertex may be moved into the intermediate queue buffer 340 pending further computation or updates.

The weight matrix buffer 350 is configured to store weight parameters required for edge computations, vertex computations, and aggregation computations. It exchanges data with the first application engine 220, the second application engine 230, and the aggregation engine 210 via the control unit 400. The weight matrix buffer 350 fetches weight data from the HBM 500 and supplies weights during computation, ensuring efficient execution of matrix operations. Ultimately, the first application engine 220, the second application engine 230, and the aggregation engine 210 use these weights to compute new states and write results back to the first application buffer 221, the second application buffer 231, or to the storage system.

The active bit vector buffer 360 stores the “active” status of each vertex. Each vertex corresponds to an active bit that indicates whether the vertex is active, i.e., whether it needs to participate in state updates of the current iteration. An active status implies that the vertex's state requires updates and that its adjacent vertices may be affected.

Each buffer is physically connected to its corresponding processing unit. Specifically, the input feature buffer 310 interfaces with the aggregation engine 210 (MAC array) via a 512-bit-wide H-Tree bus with balanced wiring delays controlled within ±5 ps. The graph structure buffer 320 is directly connected to the chain-driven traversal unit 100 via through-silicon vias (TSVs), establishing vertical transmission channels in a 3D-stacked architecture. The weight matrix buffer 350 is interconnected with the vector ALUs of both application engines through a bidirectional crossbar, supporting eight concurrent access ports.

Preferably, the chain-driven FIFO buffer 330 is directly connected to the chain-driven traversal unit 100 to store active vertices along dependency chains and to sequentially provide data to the prefetch unit 120 for adjacent-vertex acquisition and dependency-chain generation. The intermediate queue buffer 340 acts as temporary storage for active vertices and is coupled to the tracking unit 110 to buffer vertices pending processing; it supplies data to the chain-driven FIFO buffer 330 to ensure access according to dependency order. The weight matrix buffer 350 is crossbar-connected to the first application engine 220 and the second application engine 230 to provide weight data to the vector ALUs for matrix operations required by edge and vertex computations. The active bit vector buffer 360 directly interacts with the tracking unit 110 to record vertex activity states and cooperates with the chain-driven traversal unit 100 during adjacent-vertex selection to update active flags, thereby ensuring state consistency and correct task scheduling throughout computation.

The prefetch buffer 121 is a memory region for temporarily storing prefetched states of vertices and edges along dependency chains. Each entry is stored in a predefined format to facilitate fast access and subsequent processing, thereby reducing latency during computation.

The aggregation buffer 211 stores state information of source and target vertices and associated neighbor data required by the aggregation engine 210, thereby supporting subsequent aggregation computations.

The application buffer is a memory region for temporarily storing data required by the application engine during computation.

As illustrated in FIG. 3, the chain-driven traversal unit 100 comprises, in sequence, the tracking unit 110, the prefetch unit 120, and the scheduling unit 130, which are connected to perform data access.

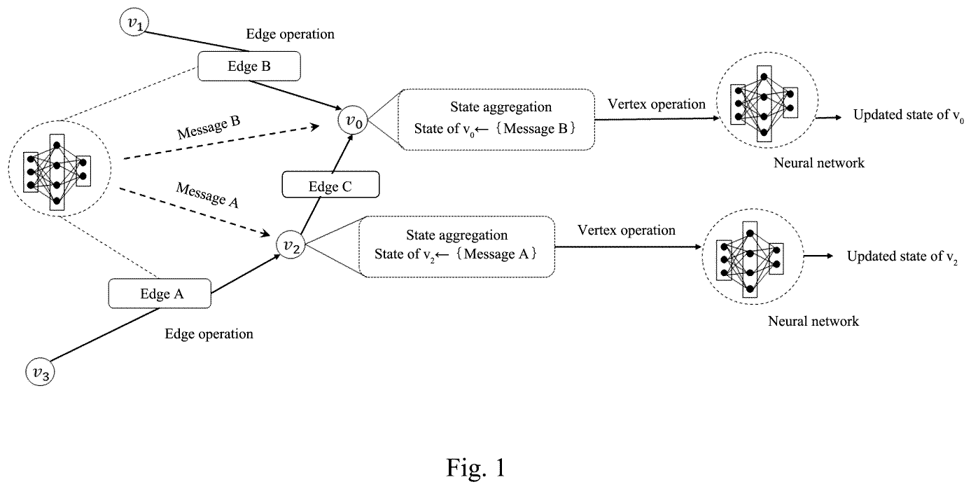

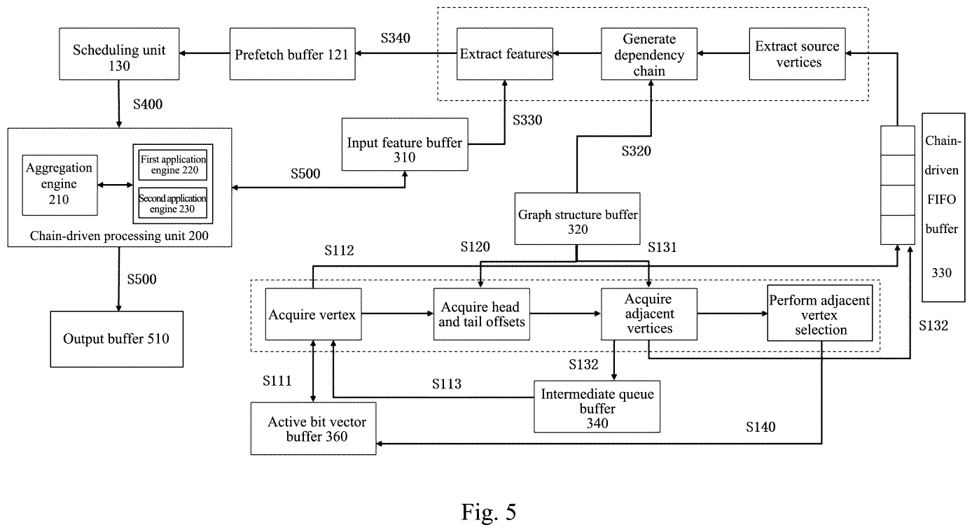

Preferably, the operating principle of the disclosed energy-efficient acceleration method for DGNNs executed by the hardware accelerator is as follows (see FIGS. 1 and 5).

S100: An unvisited active vertex is selected as a root vertex, and the tracking unit 110 dynamically tracks the original dependency chain based on a dynamic dependency-chain generation algorithm, until all active vertices have been visited. Preferably, the dynamic dependency-chain generation algorithm is a depth-first traversal algorithm.

As illustrated in FIG. 5, the tracking unit 110 implements this process via a four-stage pipeline that includes vertex acquisition, head-and-tail-offset acquisition, neighbor acquisition, and neighbor selection.

Preferably, the dynamic dependency-chain generation algorithm comprises the following steps:

S110: The tracking unit 110 acquires a vertex from either the active vertex vector buffer 360 or the intermediate queue buffer 340.

S111: Upon vertex acquisition, the tracking unit 110 first checks the intermediate queue buffer 340. If the intermediate queue buffer 340 is empty, the tracking unit 110 scans the active vertex vector buffer 360 to locate an active vertex.

S112: Once an active vertex is identified, the tracking unit 110 immediately marks that vertex as inactive in the active vertex vector buffer 360 to maintain consistency. The vertex is then transferred into the chain-driven FIFO buffer 330 for subsequent operations.

S113: If the intermediate queue buffer 340 is not empty, the tracking unit 110 retrieves an active vertex from the intermediate queue buffer 340 and proceeds to step S111 as appropriate, thereby ensuring that correct ordering and dependency relationships are preserved.

S120: The head and tail offsets of the active vertex are obtained from the vertex array in the graph structure buffer 320.

During head-and-tail-offset acquisition stage, the tracking unit 110 first reads, from the graph structure buffer 320, offset information associated with each active vertex. This offset information stores the connection relationships between each vertex and its adjacent vertices, including the positions of all adjacent edges of the vertex within the edge array. By consulting the offset array, the tracking unit 110 determines the first and last offsets (i.e., the head and tail offsets) of each active vertex. The head and tail offsets respectively define the starting and ending positions of the vertex's adjacent edges in the edge array. With the head and tail offsets, the system can accurately and efficiently access and process the adjacent edge data related to the current vertex, thereby accelerating graph traversal and computation.

S130: The unvisited adjacent vertices of the active vertex are retrieved from the adjacent vertex array in the graph structure buffer 320 and are sent to the intermediate queue buffer 340 and the chain-driven FIFO buffer 330.

S131: During neighbor acquisition, the tracking unit 110 retrieves unvisited adjacent vertices of the current active vertex from the adjacent vertex array in the graph structure buffer 320.

S132: The tracking unit 110 sends the unvisited vertices to the intermediate queue buffer 340 and the chain-driven FIFO buffer 330 for further processing. This ensures that all adjacent vertices requiring updates are correctly stored and subsequently accessed in the dependency-chain order for computation.

S140: The adjacent vertices marked as active in the active vertex vector buffer 360 are updated to inactive status to facilitate adjacent vertex selection.

The tracking unit 110 determines whether the adjacent vertices acquired during neighbor acquisition are marked as active in the active vertex vector buffer 360. If so, the tracking unit 110 immediately updates their flags in the active vertex vector buffer 360 from active to inactive, ensuring consistency and correctness of vertex states. This process helps avoid redundant processing and repeated state updates, thereby ensuring that only vertices to be updated participate in subsequent computation.

By repeating the four stages until all active vertices are visited, the tracking unit 110 ensures that the states of active vertices and their adjacent vertices are updated in the correct order. The vertex sequence in the chain-driven FIFO buffer 330 approximately represents the dependency chain among vertex states. This process tracks and manages vertex state dependencies, thereby eliminating redundant computation, optimizing the execution order and memory access, and ensuring efficient and accurate GNN inference.

S200: The active vertices are stored into the chain-driven FIFO buffer 330 in accordance with their dependency order, thereby aligning the processing sequence with the data propagation path.

To efficiently prefetch graph data along the dependency chain, the prefetch unit 120 operates through a three-stage pipeline comprising source vertex extraction, dependency chain generation, and feature extraction, as illustrated in FIG. 5.

S300: The prefetch unit 120 sequentially prefetches, from the chain-driven FIFO buffer 330 in accordance with the dependency order, source vertices, target vertices, and dependency chains between target vertices and their adjacent vertices, and, in parallel, extracts the associated graph data features. The extracted source vertices, target vertices, dependency chains, and graph data features are stored in the prefetch buffer 121. Such a pipelined architecture enables the prefetch unit 120 to perform efficient graph data management and loading, thereby reducing data latency during computation and improving overall inference efficiency.

S310: The prefetch unit 120 extracts source vertices.

Source vertices are extracted from the chain-driven FIFO buffer 330 in accordance with the dependency order.

The prefetch unit 120 sequentially retrieves vertices from the chain-driven FIFO buffer 330, each serving as a source vertex. The source vertex data present a source vertex ID. By processing active vertices one by one based on their dependency relationships, the prefetch unit 120 generates corresponding adjacent vertices and associated data for subsequent access. Through this sequential extraction from the chain-driven FIFO buffer 330, the prefetch unit 120 ensures preservation of the dependency chain order and enables efficient preloading of graph data.

S320: The prefetch unit 120 generates a dependency chain.

The prefetch unit 120 retrieves all adjacent vertices of the source vertex from the associated edge array and generates a dependency chain in the dependency order.

During dependency chain generation, the prefetch unit 120 retrieves information of the adjacent vertices (i.e., target vertex IDs) of the current source vertex from the edge array stored in the graph structure buffer 320, and uses this information to generate the dependency chain.

Specifically, the prefetch unit 120 retrieves IDs of all adjacent vertices of the source vertex from the associated edge array to construct the dependency chain in the dependency order. The dependency chain indicates the update sequence between the source vertex and its adjacent vertices, supporting subsequent feature extraction and computation. By generating the dependency chain, the prefetch unit 120 enables efficient tracking and handling of vertex dependencies, ensuring that the graph data is preloaded in accordance with computational requirements.

S330: The prefetch unit 120 extracts features.

From the input feature buffer 310, the source vertex state, target vertex state, and edge state corresponding to each edge in the dependency chain are extracted.

During feature extraction, the prefetch unit 120 acquires the source vertex state, the target vertex state, and the edge state of each edge along the dependency chain from the input feature buffer 310.

S340: The prefetch unit 120 retrieves, by referencing vertex and edge features associated with each edge, corresponding information and stores it in the prefetch buffer 121.

Specifically, each prefetched entry is stored in the prefetch buffer 121 as <source vertex ID, target vertex ID, source vertex state, target vertex state, edge state>, thereby enabling fast access to relevant vertex and edge features during subsequent computation and improving both data access efficiency and computational performance.

To further reduce unnecessary off-chip communication-particularly that of vertex states, which dominates the overall performance of DGNN inference-a chain-aware data caching (CADC) strategy is devised in the present disclosure.

The input feature buffer 310 manages the vertex states in the input feature buffer 310 based on the CADC strategy.

Upon a request for the state of a vertex, specifically when the prefetch unit 120 accesses the HBM 500 for vertex state data, the CADC strategy first examines the current state of the input feature buffer 310.

If the data entries of the input feature buffer 310 has not reached its maximum capacity, i.e., if the input feature buffer 310 is not full, it directly caches the vertex state.

If the input feature buffer 310 is full, the CADC strategy computes the priority of the vertex and replaces the currently resident vertex with the lowest priority in the input feature buffer 310.

Specifically, upon computing the priority Pri(v) of vertex v, the CADC strategy compares Pri(v) with the priorities of resident vertices in the input feature buffer 310, and replaces the resident vertex with the lowest priority if Pri(v) is greater.

According to a preferred embodiment, the priority Pri(v) of vertex v is defined as

$$Pri ( v ) = \frac{{P}_{G} ( v )}{{P}_{G}} \times {D}_{v} ,$$

where P_{G} denotes the number of dependency chains in the graph, P_{G}(v) denotes the number of dependency chains involving vertex v, and Dᵥ denotes the degree of vertex v.

The CADC strategy of the present disclosure stores frequently accessed vertex states in the on-chip buffer 300, thereby significantly reducing the demand for off-chip memory access. Since high-degree vertices are typically involved in more dependency chain propagations, their states are frequently updated during inference. The strategy caches critical vertices within the dependency chains on-chip, effectively reducing data transfer latency across memory hierarchies and lowering communication bandwidth consumption. This design improves computational efficiency and reduces system power consumption without compromising inference accuracy, demonstrating significant performance advantages especially when handling high-degree vertices and their complex dependency chains.

Step S400 is for chain-driven dynamic processing.

The chain-driven processing unit 200 adopts a dynamic pipelining approach to sequentially perform state aggregation, vertex operations, and edge operations for each vertex along the dependency chain, thereby updating the vertex states in the graph. This design enables each vertex state to be updated in parallel without waiting for updates of other vertices, significantly improving the efficiency of the inference process. By leveraging the chain-driven mechanism, the present disclosure effectively reduces computational latency and maximizes hardware utilization, thereby achieving efficient DGNN inference.

The chain-driven processing unit 200 implements a common systolic array architecture for multiply-accumulate computations, while the first active computation unit 223 manages activation functions that are critical for GNN inference. The aggregation scheduler of the aggregation engine 210 and the schedulers of the two application engines coordinate pipeline execution and allocate workloads to the aggregation engine 210 and the second application engine 230. Both engines operate under a HyGCN-like task-disaggregated aggregation model, achieving balanced workload distribution and task-level parallelism.

The chain-driven dynamic processing is executed through the following steps.

At S410, the scheduling unit 130 schedules both source and target vertices from the prefetch buffer 121 into the aggregation buffer 211 of the aggregation engine 210. This ensures that the aggregation engine 210 has access to the state information of all adjacent vertices required for the current computation, enabling effective state aggregation.

Preferably, during scheduling, the scheduling unit 130 reads data from the prefetch buffer 121 of the prefetch unit 120 and classifies each vertex based on its role (i.e., source or target). Specifically, the scheduling unit 130 parses the vertex ID in each data packet and consults the active bit vector buffer 360 to determine whether the vertex is currently active.

The scheduling unit 130 then stores the state of the source vertex along with the states of its adjacent target vertices into the aggregation buffer 211 of the aggregation engine 210 based on computational requirements, enabling efficient state aggregation. At the same time, the scheduling unit 130 adjusts data transmission priorities dynamically to prioritize vertices on the critical path of the dependency chain, minimizing latency caused by data dependencies and ensuring efficient dataflow and task scheduling.

Specifically, for each target vertex, the scheduling unit 130 retrieves its state from the prefetch buffer 121 and determines its scheduling priority based on its importance within the dependency chain. The vertex state is stored into the aggregation buffer 211 of the aggregation engine 210 for state aggregation, while related data is simultaneously transmitted to the second application engine 220 for edge computation or vertex updates.

Preferably, a critical path is defined as a sequence of vertices in the dependency chain that most significantly affects task execution order and overall inference efficiency. During DGNN inference, if a vertex has not yet completed computation and subsequent dependent vertices must wait for its result, the path including this vertex is considered a critical path. Preferably, upon the completion of each vertex computation, the scheduling unit 130 preferably re-evaluates the critical path by calculating: (1) the remaining computation latency, i.e., the total estimated computation time of unprocessed vertices in the dependency chain; and (2) the dependency depth, i.e., the longest path length from a template vertex to the final output node. The path corresponding to the template vertex with the largest product of remaining latency and dependency depth is identified as the current critical path.

The scheduling unit 130 prioritizes allocating computing resources to target vertices on the critical path, ensuring their state updates are completed as quickly as possible to reduce stalls and dependency-related waiting. After updates are completed, the scheduling unit 130 stores the updated target vertex states into either the second application buffer 230 or the high-bandwidth memory (HBM) 500, supporting subsequent inference steps and improving the overall efficiency of the DGNN.

Preferably, the scheduling unit 130 assigns scheduling priorities to vertices based on their importance within the dependency chain, thereby optimizing task scheduling and minimizing computation delays caused by data dependencies. Vertices on the critical path are given the highest priority, as they directly affect the progress of subsequent computations, and are preferentially dispatched to the aggregation buffer 211 for processing.

A regular active vertex, located in a dependency chain but not on the current critical path, influences the progress of some downstream vertices but has a lower impact on overall inference efficiency compared to critical-path vertices. Accordingly, its scheduling priority is lower than that of critical-path vertices. Scheduling is permitted only when (1) the computing resource utilization of critical-path vertices is below a threshold (e.g., <80%), and (2) no higher-priority tasks are pending, thereby ensuring ordered execution of computation tasks.

A non-dependency-chain active vertex, which is not associated with any dependency chain, only affects itself or a local subgraph and does not contribute to the core dataflow. Therefore, it is assigned the lowest scheduling priority and is dispatched only when computing resources are sufficiently available, so as not to interfere with core tasks. The conditions for scheduling such a vertex are: (1) no critical-path or regular active vertices are pending, and (2) the resource idle rate exceeds a predefined threshold (e.g., >90%).

By leveraging this scheduling priority mechanism, the scheduling unit 130 ensures efficient execution of computation tasks and enhances the overall inference performance of the DGNN. Preferably, to prevent pipeline congestion associated with state aggregation, a dedicated G-PE and A-PE design is introduced. As illustrated in FIG. 3, each G-PE in the aggregation engine 210 comprises eight parallel aggregation modules. Each module contains two input queues: the first input queue stores source vertex states, and the second input queue stores target vertex states. Data are processed via an adder and a multiplexer, which determine whether the result is output directly or cached as an intermediate value in the intermediate queue buffer 340.

Additionally, the aggregation engine 210 employs feature-level parallelism to improve state aggregation efficiency. Each A-PE in the first application engine 220 and the second application engine 230 performs edge and vertex update operations-including edge operations and vertex operations-via embedded matrix accumulation units that execute matrix-vector multiplications and support nonlinear activation functions. When no edge computation is required, the two computing modules of an A-PE can dynamically merge into a larger unit to optimize resource utilization.

According to a preferred embodiment, the aggregation engine 210 performs state aggregation by preloading the adjacent vertex states generated in the previous computation into the aggregation buffer 211 and applying an aggregation operator to generate aggregation results.

At S420, the scheduling unit 130 schedules the state of the source vertex and its corresponding edge state to the second application buffer 231 of the second application engine 230. This enables parallel execution of state aggregation by the aggregation engine 210 and edge computation by the second application engine 230. This scheduling ensures that subsequent vertex operations, including edge application and state updates, have the necessary data support, maintaining smooth dataflow across active computation units and enhancing GNN inference efficiency.

According to a preferred embodiment, the second application engine 230 performs edge computation by fusing the states of the source and target vertices with edge attribute data to generate edge message-passing features, which are then transmitted to the first application engine 220.

During edge operations (i.e., edge computation phase), the second application engine 230 computes the state of each edge by applying a neural network to transform the source vertex state, target vertex state, and edge attributes into a message.

The transformation is defined as:

$${Message}_{e} = {f}_{e} ( {State}_{{v}_{s}} , {Satte}_{{v}_{t}} , {Attr}_{e} ) ,$$

where fₑ denotes a transformation function for edge operations, Stateᵥ_{ₛ} and Stateᵥ_{ₜ} denote the states of the source and target vertices, respectively, and Attrₑ denotes the edge attributes. This stage integrates vertex states with edge attributes to provide a basis for subsequent state propagation and aggregation.

During state aggregation (i.e., source vertex fusion), the aggregation engine 210 collects messages generated by edge operations from adjacent vertices and aggregates them to update the state of the target vertex.

The aggregation operation typically employs basic mathematical functions such as summation (Sum), mean (Mean), or maximum (Max):

$${Agg}_{v} = Aggregate ( \{ {Message}_{e} \vert e ∈ N ( v ) \} ) ,$$

where Aggᵥ denotes the aggregation result of the target vertex v, and N(v) represents the set of adjacent vertices of v. This stage reduces the dimensionality of adjacent vertex states, yielding a compact representation for updating the target vertex state.

At S430, the aggregation results from the aggregation engine 210 and the edge computation results from the second application engine 230 are scheduled to the first application engine 220 for fusion, generating the final state of the target vertex.

According to a preferred embodiment, the first application engine 220 computes the updated state of the target vertex using matrix-vector multiplication and nonlinear transformations.

During vertex operations, the target vertex generates a new state based on its current state and the result from state aggregation.

Preferably, the first application engine 220 performs vertex updates according to the neural network transformation:

$${State}_{v}^{new} = {f}_{v} ( {State}_{v}^{current} , {Agg}_{v} ) ,$$

where fᵥ represents a transformation function for vertex operations,

$${State}_{v}^{current}$$

denotes the current vertex state, and Aggᵥ denotes the aggregation result for the target vertex v. This operation integrates the historical state of the vertex with that of its neighbors to generate an updated vertex state.

Supported by the dynamic pipeline, vertex state updates, neighbor state aggregation, and edge operations can be executed concurrently, maximizing parallelism and computational efficiency. This dynamic execution reduces latency caused by data transfer and computation, significantly accelerating the inference process.

At S500, the first application engine 220 sends the updated state of the target vertex to the output buffer 510 and the input feature buffer 310.

In this manner, the first application engine 220 integrates intermediate results from previous computations and outputs the final state of each target vertex, ensuring correctness and efficiency in the GNN inference process.

As shown in FIG. 1, the left-side diagram includes vertices v₀, v₁, v₂, v₃ and three edges among them. Edge A is directed from vertex v₃ to vertex v₂, and an edge operation is performed on it to generate message A. Edge B is directed from vertex v₁ to vertex v₀, and an edge operation is performed to generate message B. Edge C is directed from vertex v₂ to vertex v₀.

The tracking unit 110 accesses all active vertices and acquires the current state information of vertices v₀, v₁, v₂, v₃, as well as the three edges among them. The prefetch unit 120 preloads, in dependency order, the source vertices, target vertices, and the dependency chains connecting each target vertex with its adjacent vertices. Specifically, the prefetch unit 120 reads the current state of vertex v₃, generates message A, and transmits the state of vertex v₃ to the target vertex v₂ via edge A. It then reads the current state of vertex v₁, generates message B, and transmits the state of vertex v₀ to the target vertex v₀ via edge B. No edge operation is performed on edge C by the prefetch unit 120.

The scheduler 130 dispatches the information of target vertices v₀ and v₂ to the second application buffer 231 of the second application engine 230. The aggregation engine 210 performs state aggregation for each target vertex. For target vertex 12, the aggregation is based on message A and its previous state to generate an updated state. For target vertex v₀, the aggregation is based on message B and its previous state to generate an updated state.

The second application engine 220 integrates a neural network model for vertex and edge operations. Upon receiving aggregated messages (e.g., message A or message B) or vertex states, it applies the vertex operation process to generate updated vertex states (e.g., for target vertex v₂) or new messages. Preferably, vertex operations are executed by the built-in neural network based on a transformation function.

As described above, the processing paths for vertex information are as follows:
Edge A: vertex v₃→message A→vertex v₂→state aggregation→vertex operation→new state of vertex v₂.
Edge B: vertex v₁→message B→vertex v₀→state aggregation→vertex operation→new state of vertex v₀.

The present disclosure offers the following advantages:

First, fast convergence in iterative graph processing: By implementing chained awareness, the present disclosure normalizes data access and dynamically tracks the dependency chains among active vertices. Each active vertex is continuously processed according to its order in the chain, avoiding redundant data access and computations associated with vertex state updates. This allows vertex states to propagate efficiently along the dependency chain, significantly accelerating convergence in iterative graph processing.

Second, high utilization of hardware accelerators: The present disclosure introduces a chained-aware data caching (CADC) strategy, which prioritizes caching frequently used dependency chain states in on-chip memory. This reduces unnecessary off-chip communication, improves data locality, overcomes performance bottlenecks caused by excessive data transfer, and enhances the effective utilization of hardware accelerators.

### Embodiment 2

This embodiment is a further refinement of Embodiment 1; repeated content is omitted for brevity.

In this example, a graph is considered where which each vertex represents a user and each edge represents a user relationship (e.g., friendships in a social network). The objective is to use the proposed energy-efficient acceleration method for dynamic graph neural networks and corresponding hardware accelerator to predict user activity levels and perform inference using a graph neural network.

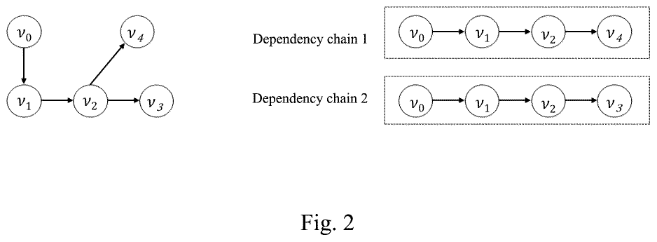

As illustrated in FIG. 2, the graph contains:
Vertices: v₀, v₁, v₂, v₃, v₄;
Edges: (v₀, v₁), (v₁, v₂), (v₂, v₃), (v₂, v₄).

Each vertex has an initial state (e.g., user activity level), and each edge has a weight (e.g., strength of friendship).

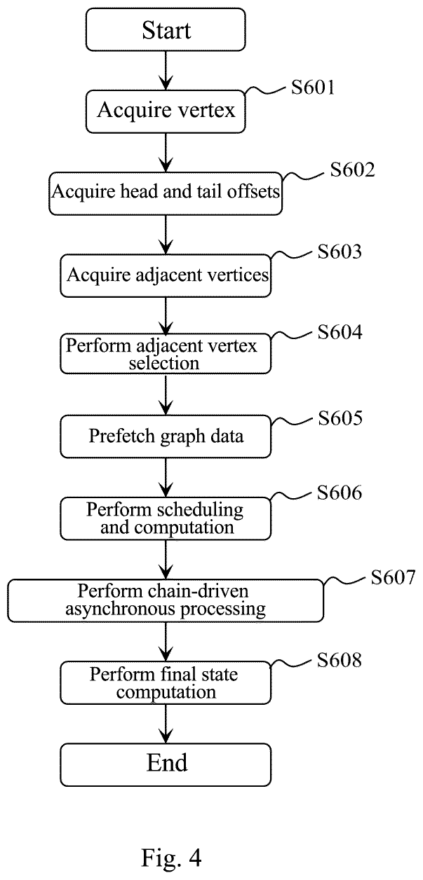

A flow diagram illustrating the implementation of the energy-efficient acceleration method for dynamic graph neural networks of this embodiment is shown in FIG. 4.

S601: Acquire vertex.

Operation: Assume vertex v₀ is active. The tracking unit 110 retrieves vertex v₀ from the chain-driven FIFO buffer 330 as a source vertex.

Data transfer: The tracking unit 110 in the chain-driven traversal unit 100 extracts the state of source vertex v₀ from the active bit vector buffer 360, marks it as inactive, and sends it to the chain-driven FIFO buffer 330 for subsequent operations.

S602: Acquire head and tail offsets.

Operation: The tracking unit 110 obtains the head and tail offsets of the source vertex Vo, indicating the storage location of its adjacency information in the graph structure buffer 320 (e.g., edge array).

Data transfer: The tracking unit 110 identifies, based on the head and tail offsets, that the adjacent vertex of the source vertex v₀ is vertex v₁, and retrieves the corresponding edge data from the graph structure buffer 320.

S603: Acquire adjacent vertices.

Operation: The tracking unit 110 retrieves adjacent vertex v₁ of source vertex v₀ from the edge array.

Data transfer: The adjacent vertex 11 is stored by the tracking unit 110 into the intermediate queue buffer 340 and the chain-driven FIFO buffer 330 for subsequent processing.

S604: Perform adjacent vertex selection.

Operation: The tracking unit 110 checks whether adjacent vertex v₁ is active. If so, the tracking unit 110 marks the adjacent vertex v₁ as inactive.

Data update: The tracking unit 110 updates the state of the adjacent vertex v₁ to inactive to maintain vertex state consistency.

S605: Prefetch graph data.

Operation: The prefetch unit 120 sequentially performs source vertex retrieval, dependency chain generation, and feature extraction. First, the prefetch unit 120 retrieves source vertex v₀ from the chain-driven FIFO buffer 330, then generates the dependency chain where the source vertex v₀ depends on adjacent vertex v₁.

Data transfer: The prefetch unit 120 retrieves the states of source vertex v₀ and adjacent vertex v₁, as well as the edge state (e.g., edge weight), from the input feature buffer 310, storing them in the prefetch buffer 121 as <source vertex ID, target vertex ID, source vertex state, target vertex state, edge state>.

S606: Perform scheduling and computation.

Operation: The scheduling unit 130 transfers the states of the source vertex v₀ and the adjacent vertex v₁ to the aggregation buffer 211 of the aggregation engine 210, and transfers the state of the source vertex v₀ along with the edge state to the first application buffer 221 of the first application engine 220.

Data transfer: The scheduling unit 130 ensures that data are transmitted in dependency order, thereby ensuring the smooth execution of aggregation and edge operations.

S607: Perform chain-driven asynchronous processing.

Operation: The chain-driven processing unit 200 sequentially performs state aggregation, vertex operation, and edge operation for each target vertex.

State aggregation: The aggregation engine 210 aggregates the states of the source vertex v₀ and the adjacent vertex v₁ to generate an aggregation result for the adjacent vertex 121, serving as the target vertex v₁.

Edge operation: The first application engine 220 performs edge computation by combining the states of the source vertex v₀ and the target vertex v₁, as well as the edge state.

Vertex operation: The second application engine 230 updates the state of the target vertex v₁ (e.g., via a neural network).

Data transfer: The aggregation results from the aggregation engine 210 and the edge operation results from the second application engine 230 are transmitted to the first application engine 220 for final state update.

S608: Perform final state computation.

Operation: Upon completion of their respective computations, the aggregation engine 210 and the second application engine 230 immediately send their results to the first application engine 220 for final vertex state computation.

Data transfer: After receiving the aggregation and edge operation results, the first application engine 220 updates the final state of target vertex v₁, and transmits the updated state to the output buffer 510 and the input feature buffer 310 for subsequent computations.

When applied to social network user activity prediction, the present disclosure significantly improves inference efficiency and performance. By combining dependency chain tracking with dynamic pipelined processing, it efficiently manages inter-vertex dependencies, avoids redundant computations, and accelerates state updates through parallel execution. Furthermore, efficient data prefetching and adaptive task scheduling optimize data access patterns and load distribution during computation, ensuring maximal utilization of hardware resources. Consequently, the present disclosure substantially increases computational efficiency while reducing latency in processing large-scale graph data, making it suitable for large-scale applications such as social networks.

As an illustrative embodiment, the present disclosure is further described with reference to the physical hardware modules of an energy-efficient hardware accelerator for dynamic graph neural networks.

The chain-driven traversal unit 100 is implemented as a graph parsing state machine (ASIC). The chain-driven processing unit 200 is implemented as a multi-core vector processor array (DSP hard-core cluster). The on-chip buffer 300 is a dual-port BRAM cache array.

The aggregation engine 210 comprises a MAC array (DSP hard core+BRAM). The first application engine 220 is a vector ALU computing module (FPGA programmable logic). The second application engine 230 is an edge state update module (FPGA programmable logic). The switch 250 is a crossbar interconnect module. The high-bandwidth memory 500 is an HBM memory controller (PHY hard core+GDDR6 interface).

The on-chip buffer 300 employs a heterogeneous memory architecture for energy-efficient data management, its key modules includes: chain-driven FIFO buffer 330 built with mixed BRAM and URAM, with FIFO control for dependency chains implemented via ring pointer registers and hardware state machines; input feature buffer 310 comprising dual-port BRAM array with chain-aware data caching, dynamically optimizing feature residency based on vertex participation in dependency chains; graph structure buffer 320 using high-density URAM to store vertex offsets and adjacency lists, with sparse-coding compression circuits increasing storage density by approximately 1.8×; and TCAM-based weight matrix buffer 350, supporting parallel edge weight queries at a load bandwidth of 256 GB/s. Moreover, prefetch buffer 121 is embedded within the BRAM array control logic of the input feature buffer 310, rather than being a standalone module, and shares the same physical region and interfaces with BRAM address generators and data paths through a dedicated prefetch channel, thereby enabling seamless integration of prefetch, storage, and computation operations. Prefetch operations are scheduled by the chain-aware controller according to dependency chain priority, dynamically adjusting prefetch depth and replacement policies.

The graph parsing state machine (ASIC) selects unvisited active vertices as root vertices and tracks dependency chains using a dynamic chain generation algorithm embedded in ASIC state-transition logic until all active vertices are processed. Dependency chains are sequentially stored in the chain-driven FIFO buffer 330 (a ring queue comprising BRAM and URAM), and the hardware FIFO controller thereof (integrated into an ASIC pointer register set) ensures strict alignment between processing order and data propagation paths.

During the prefetch stage, the prefetch buffer 121 (embedded in the dual-port BRAM array of the input feature buffer 310) receives source vertices, target vertices, adjacency chains, and associated feature data from the chain-driven FIFO buffer 330 through the dedicated prefetch channel. Prefetch operations are dynamically scheduled by the chain-aware controller (implemented in FPGA programmable logic) of the input feature buffer 310 in accordance with dependency chain priority.

Upon dispatching computation tasks, the DSP hard-core cluster of the multi-core vector processor array 200 performs hardware scheduling.

Source and target vertices from the prefetch buffer 121 are pushed to a BRAM partition of the MAC array (aggregation buffer 211) for neighborhood feature weighted summation by DSP hard cores. Source vertex states and edge states are sent to a BRAM buffer of the edge state update module (implemented in FPGA programmable logic as the second application engine 230) for edge operations such as gradient computation.

Parallel computation results are routed via the switch 250 (crossbar interconnect module implemented using FPGA high-speed routing resources) to the first application engine 220 (vector ALU module implemented with FPGA LUTs and DSP slices), where nonlinear fusion operations, including ReLU activation, are performed. The resulting target vertex states are output to the high-bandwidth memory 500 (HBM PHY hard core+GDDR6 interface).

It should be noted that the above-mentioned embodiments are exemplary. Those skilled in the art, inspired by the present disclosure, may devise various solutions within the scope and protection of the present disclosure. Furthermore, those skilled in the art will recognize that the specification and accompanying drawings provided herein are illustrative and form no limitation to any of the appended claims. The protection scope of the present application is defined by the appended claims and their equivalents. The specification provided herein encompasses multiple inventive concepts, with terms like “preferably” or “according to a preferred embodiment” indicating distinct concepts in respective paragraphs. The applicant reserves the right to file divisional applications for each inventive concept.

What is claimed is:

1. An energy-efficient acceleration method for dynamic graph neural networks (DGNNs), the method comprising:
using an unvisited active vertex as a root vertex, dynamically tracking an original dependency chain based on a dynamic dependency chain generation algorithm, until all active vertices are visited; storing the active vertices into a chain-driven FIFO buffer in accordance with a dependency order among the active vertices, thereby aligning a processing sequence with a data propagation path;
sequentially prefetching, from the chain-driven FIFO buffer in accordance with the dependency order, a source vertex, a target vertex, a dependency chain between the target vertex and its adjacent vertices, and graph data features associated with the dependency chain, and storing them into a prefetch buffer;
scheduling the source vertex and the target vertex from the prefetch buffer to an aggregation buffer of an aggregation engine, and further scheduling a source vertex state and its corresponding edge states to a second application buffer of a second application engine, such that the aggregation engine and the second application engine execute state aggregation and edge computation in parallel; and
scheduling an aggregation result from the aggregation engine and an edge computation result from the second application engine to a first application engine for fusion, thereby generating a final state of the target vertex.

2. The method of claim 1, wherein the dynamic dependency chain generation algorithm comprises:
acquiring vertices from either an active bit vector buffer or an intermediate queue buffer;
acquiring head and tail offsets of an active vertex from a vertex array of a graph structure buffer;
acquiring unvisited adjacent vertices of the active vertex from an adjacent vertex array of the graph structure buffer and sending the adjacent vertex to the intermediate queue buffer and the chain-driven FIFO buffer; and
updating entries corresponding to the adjacent vertices in the active bit vector buffer from active to inactive, thereby enabling subsequent adjacent-vertex selection.

3. The method of claim 2, wherein the step of prefetching comprises:
extracting the source vertex from the chain-driven FIFO buffer in accordance with the dependency order;
retrieving all adjacent vertices of the source vertex from an associated edge array and generating the dependency chain in the dependency order; and
from an input feature buffer, extracting the source vertex state, a target vertex state, and the edge states corresponding to each edge in the dependency chain.

4. The method of claim 3, further comprising a chain-aware data caching strategy that is configured to manage the vertex states in the input feature buffer,
wherein, upon a request for the state of a said vertex, if the input feature buffer has not reached its maximum capacity, the vertex state is cached directly, or otherwise, a priority of the vertex is computed and the vertex replaces a resident vertex with the lowest priority.

5. The method of claim 4, wherein the priority of the vertex is defined as:
$$Pri ( v ) = \frac{{P}_{G} ( v )}{{P}_{G}} \times {D}_{v} ,$$
where P_{G} denotes a number of said dependency chains in a graph, P_{G}(v) denotes a number of said dependency chains involving the vertex v, and Dᵥ denotes a degree of the vertex v.

6. The method of claim 5, wherein the aggregation engine executes the state aggregation by:
preloading the adjacent vertex states generated in the previous computation into the aggregation buffer and applying an aggregation operator to generate the aggregation result.

7. The method of claim 6, wherein the second application engine executes the edge computation by:
fusing the states of the source and target vertices with edge attribute data to generate edge message-passing features, and transmitting the edge message-passing features to the first application engine.

8. The method of claim 7, wherein the first application engine operates by:
computing an updated state of the target vertex by performing matrix-vector multiplication and nonlinear transformation; and
sending the updated state of the target vertex to an output buffer and the input feature buffer.

9. An energy-efficient hardware accelerator for dynamic graph neural networks (DGNNs), the hardware accelerator comprising:
a chain-driven traversal unit, configured to track a dependency chain of an active vertex using a dynamic dependency chain generation algorithm, store the active vertices into a chain-driven FIFO buffer in accordance with a dependency order among the active vertices, thereby aligning a processing sequence with a data propagation path, and sequentially prefetch, from the chain-driven FIFO buffer in accordance with the dependency order, a source vertex, a target vertex, a dependency chain between the target vertex and its adjacent vertices, and graph data features associated with the dependency chain, and store them into a prefetch buffer;
a chain-driven processing unit, configured to schedule a source vertex and/or a target vertex of a prefetch buffer to an aggregation engine, and further schedule a source vertex state and edge states to a second application engine, thereby enabling parallel execution of aggregation and edge computation, and send results of the parallel execution to a first application engine, thereby generating a final state of the target vertex; and
an on-chip buffer, comprising a chain-driven FIFO buffer, a prefetch buffer, and an input feature buffer, wherein the input feature buffer manages vertex states using a chain-aware data caching strategy.

10. The hardware accelerator of claim 9, wherein the chain-aware data caching strategy comprises:
upon a request for the state of a said vertex, if the input feature buffer has not reached its maximum capacity, the vertex state is cached directly, or otherwise, a priority of the vertex is computed and the vertex replaces a resident vertex with the lowest priority.

11. The hardware accelerator of claim 10, wherein the chain-driven processing unit adopts a multi-core vector processor array architecture and comprises an aggregation engine, which is a MAC array, and two application engines, which are vector ALUs.

12. The hardware accelerator of claim 11, wherein the aggregation engine is physically connected to the first application engine, and the first application engine is physically connected to the second application engine,
wherein the aggregation engine comprises an aggregation buffer and an aggregation scheduler, and the first application engine comprises a first application buffer, a first application scheduler, and a first active computation unit.

13. The hardware accelerator of claim 12, wherein the first application buffer is configured to store input data that include the source vertex state, a target vertex state, and the edge states,
the first application scheduler is configured to read data from the first application buffer and assign tasks to the first active computation unit, and
the first active computation unit feeds computation results to the first application buffer,
wherein the first application buffer transmits the computation results to the aggregation engine, the second application engine, or a high-bandwidth memory, thereby completing data exchange.

14. The hardware accelerator of claim 13, wherein the second application engine comprises a second application buffer, a second application scheduler, and a second active computation unit, and is connected to the first application engine via a switch,
wherein the second application buffer is configured to store the source vertex state and the edge states for use by the second application engine in edge computation and vertex updates.

15. The hardware accelerator of claim 14, wherein the second application buffer is configured to receive and store input data that include a target vertex initial state, an aggregation result, and an edge computation result,
the second application scheduler is configured to read data from the second application buffer and assign tasks to the second active computation unit, and
the second active computation unit is configured to compute a final state of the target vertex, and store it to the second application buffer,
wherein the second application buffer transmits the computation result to the high-bandwidth memory or a subsequent first application engine for storage, thereby completing vertex updates.

16. The hardware accelerator of claim 15, wherein the switch is configured to merge the first application engine and the second application engine into a single, larger application engine.

17. The hardware accelerator of claim 16, wherein the switch merges the first application engine and the second application engine by dynamically adjusting data paths, sharing the computing resources, and unifying task scheduling.

18. The hardware accelerator of claim 17, wherein in a merge mode, when computing tasks are biased toward vertex updates or explicit edge computation is not required, the switch reconfigures a dataflow such that the first application buffer and the second application buffer share data storage space, and the first active computation unit cooperates with the second active computation unit to perform vertex computation, thereby improving computing resource utilization and enhancing computing throughput.

19. The hardware accelerator of claim 18, wherein the chain-driven processing unit communicates with the chain-driven FIFO buffer via a duplex crossbar network that supports 8-way concurrent access for prefetching vertex features and edge weight data, and is crossbar-connected to the input feature buffer, which is implemented using a multi-bank architecture, thereby enabling rapid loading and updating of 32-bit floating-point vector states.

20. The hardware accelerator of claim 19, wherein a control unit is configured to manage global tasks, allocate computing resources, control dataflow, and perform synchronization management, and to coordinate execution of the first application engine, the second application engine, the aggregation engine, and the scheduling unit, thereby ensuring a dynamic pipeline with efficient operation, wherein the control unit dynamically allocates the computing resources and, in conjunction with the switch, optimizes execution by merging the first active computation unit and the second active computation unit, and further manages the input feature buffer to improve memory access efficiency, and wherein the control unit further synchronizes the computation tasks to prevent data conflicts and handles exceptions, thereby ensuring stable and efficient DGNN inference.
